(19) United States
(12) Patent Application Publication
(10) Pub. No.: US 2013/0255688 A1
(43) Pub. Date: Oct. 3, 2013

(54) REGENERATIVE CARTRIDGE OF A REBREATHER

(71) Applicants: LEONID LITMAN, Donetsk (UA); Irving M. Weiner, Harrisville, MI (US); Mykola Kotiukhov, Donetsk (UA); Volodymyr Popov, Donetsk (UA)

(72) Inventors: LEONID LITMAN, Donetsk (UA); Irving M. Weiner, Harrisville, MI (US); Mykola Kotiukhov, Donetsk (UA); Volodymyr Popov, Donetsk (UA)

(73) Assignee: JSC "DONETSK MINE RESCUE EQUIPMENT COMPANY", Donetsk (UA)

(21) Appl. No.: 13/786,500

(22) Filed: Mar. 6, 2013

(30) Foreign Application Priority Data
Mar. 26, 2012 (UA) UA U2012 02695

(51) Int. Cl. A62B 19/00

(52) U.S. Cl. CPC A62B 19/00
USPC 128/205.12

(57) ABSTRACT

A regenerative cartridge of a rebreather for isolating self-rescuers with chemically-bonded oxygen. The cartridge includes: a hermetic housing; a perforated shell arranged in the housing with an annular gap between the shell and the side wall of the housing and made with a central channel having perforated walls; a regenerative product arranged in the perforated shell; a heat-gas distributor arranged in the bulk of the regenerative product. The heat-gas distributor is made in the form of perforated plates positioned in a radial arrangement in the bulk of the regenerative product. One of the lateral sides of each perforated plate is made with a longitudinal bend of L-shaped cross-section. The walls of the L-shaped bends of the neighboring perforated plates are successively connected between them to form a central channel confined by the shelves of the L-shaped bends.

This invention relates to the respiratory organ protection systems and in particular to the isolating self-rescuers with chemically bonded oxygen, which find applications in the mining, chemical and other industries.

The self-rescuers are destined for extraordinary short-term protection of the respiratory organs under emergency circumstances associated with formation of a medium unusable for breathing.

Main properties responsible for self-rescuer usability are such as protective action time respiration resistance, gas mixture temperature, weight and dimensions, simplicity and manufacturability of the design.

Generally, a self-rescuer comprises a hermetic housing with bearing means (belts, clasps a. o.), a regenerative cartridge positioned inside of the housing and filled with a regenerative product, a triggering means connected with the regenerative cartridge, a means to realize the closed circuit function of the self-rescuer, and a gas mixture passage system (a convoluted tube connecting the human respiratory organs with the self-rescuer, a breathing bag, a gas channel system in the regenerative cartridge) of a selected scheme. To decrease the temperature of the regenerative product and achieve a uniform temperature distribution through its whole bulk, there serves, as a rule, a heat-gas distributor positioned in the bulk of the regenerative product inside of the regenerative cartridge.

Two groups of self-rescuers amid the other known systems may be picked out depending on their gas mixture passage scheme: that with a sequential passage of the gas mixture and that with a pendulum passage of the gas mixture.

In self-rescuers with sequential passage of the gas mixture, an exhaled gas mixture is directed to a regenerative product, where absorption of carbon dioxide and moisture, and oxygen enrichment of the gas mixture occur. Scrubbed gas mixture flows into the breathing bag. At inhale, the gas mixture from the breathing bag comes directly to the respiratory organs. So, in this case, the gas mixture during one “inhale-exhale” cycle passes through the bulk of the regenerative product only once.

In self-rescuers with a pendulum scheme of a gas mixture passage, the exhaled gas mixture is directed to the regenerative product, where the absorption of carbon dioxide and moisture and enrichment of the gas mixture by oxygen occur. Scrubbed gas mixture comes into the breathing bag. At inhale, the gas mixture from the breathing bag passes in the opposed direction through the regenerative product, where it is additionally scrubbed from carbon dioxide, additionally enriched by oxygen and comes to the respiratory organs. In this case, during one “inhale-exhale” cycle the gas mixture passes twice through the bulk of the regenerative product, that increases the level of regeneration of the gas mixture while remaining the same the characteristics of the self-rescuer.

Besides, prior art self-rescuers, by their direction of passage of the gas mixture through the regenerative cartridge, may be divided into those with axial direction, where the gas mixture passes through the regenerative product along the longitudinal axis of the cartridge, and those with radial direction, where the gas mixture is directed through the regenerative product perpendicularly to the longitudinal axis of the cartridge, as a rule, using a central perforated tube to supply/withdraw the gas mixture.

Taking into consideration the features of the claimed regenerative cartridge, there were investigated only those known solutions, in which the pendular scheme of the gas mixture passage with a radial passage of the gas mixture through the regenerative cartridge had been realized using a central perforated tube.

Thus, RU, 2091099, IPC A62B 19/00, filing date Jul. 19, 1997, describes a regenerative cartridge of a rebreather (a rebreather means a self-contained breathing apparatus).

The regenerative cartridge comprises a housing, which has an oval form and inside of which a shell is positioned in a coaxial arrangement with an annular gap between the shell and the interior surface of the housing. Along the longitudinal axis of the housing of the cartridge a central perforated tube with a filter inside of the tube is arranged. Space between the shell and the central tube is filled with a granular regenerative product. Over the regenerative product there a starting briquette is positioned. There are also triggering means and sockets fixed on a cover provided for connection to a breathing bag and to an assembly serving for isolation of the respiratory organs.

The shell is made in oval form. Wall of the shell has the perforated and non-perforated parts. Non-perforated parts are situated on the opposite sides of the shell about its longer axis over the whole height of the shell. Perforated parts are situated on the opposite sides of the shell over its whole height. The widths of the perforated and non-perforated parts are fitted experimentally regarding to the dimensions of the layer of the regenerative product, the dimensions of the regenerative product granules, and the flow velocity of the circulating air. Direction of the air flow in the cartridge is radial, that is perpendicular to the longitudinal axis of the cartridge.

Assemblage of the cartridge is carried out in a usual way for such articles. Firstly, the inner space of the shell with the central tube, previously placed into it, is filled with the regenerative product, the starting briquette is placed, and the shell is harbored into the housing with the lid. Then, the filter is placed into the central tube.

The prior art solution enables to simplify the design of the regenerative cartridge and to increase the manufacturability of its production, while simultaneously insuring effective functioning of the regenerative product.

Common features of the prior art and claimed solution are as follows: the regenerative cartridge of a rebreather, which includes a hermetic housing with an inhale-exhale socket and a socket of the breathing bag, a perforated shell arranged in a housing with annular gap between the shell and the side wall of the housing and made with a central channel with perforated walls, a regenerative product arranged in the inner space of the perforated shell, where said central channel is connected with an inhale-exhale socket and said annular gap is connected with the socket of the breathing bag.

During regeneration of the exhaled air-gas mixture in the regenerative product exothermic reactions take place producing large quantity of heat. As a result, in the bulk of the regenerative product some local zones of high temperature arise, in which a melting of components of the regenerative product becomes possible. Creation of such zones worsens the gas-dynamic of passage of the gases through the bulk of the regenerative product, and decreases the degree of usage of the regenerative product. The air, supplied from the regenerative cartridge through a convoluted tube to the respiratory organs, has a high temperature. The heat air brings in an additional stress burden to the user being in emergency situation, and can result in switching off the breathing set. Oval form of the housing and shell as well as presence of the non-perforated parts of the shell result in non-uniform usage of the regenerative product owing to a non-uniform distribution of the air-gas mixture flows through the bulk of the regenerative product.

To get a uniform distribution of the temperature through the bulk of the regenerative product, regenerative cartridges of prior art employ heat-gas distributors, which prevent creation of the local high-temperature zones, insure a uniform temperature distribution and a removal of surplus heat energy from the cartridge outwards.

In this view, a prior art regenerative cartridge of a rebreather known from DE, 2852240, IPC A62B 19/00, filing date Dec. 2, 1978, includes an oval shaped housing with a lid and a bottom, and a shell which is coaxially arranged inside of the housing and has perforated parts positioned on the opposite sides of the shell, symmetrically about the short axis of the cross-section of the shell. Between the internal surface of the housing and the perforated parts of the shell there are provided crescent gaps. Inside of the housing a central perforated tube is arranged. In the space between the tube and the shell a regenerative product is arranged, separated into layers by metal grids. Additionally, there are intermediate elements with L-shaped cross-section, presence of which along with the grids contributes to the uniform temperature distribution through the bulk of the regenerative product and to the removal of the reaction heat.

Common features of the prior art and the claimed solution are as follows: a regenerative cartridge of a rebreather including a hermetic housing with an inhale-exhale socket and a socket of a breathing bag, a perforated shell arranged in a housing with an annular gap between the shell and the side wall of the housing and made with a central channel having perforated walls, a regenerative product arranged in the room of the perforated shell, a heat-gas distributor arranged in the bulk of the regenerative product.

Presence of the multiple horizontal grids with intermediate elements of L-shaped cross-section in the bulk of the regenerative product complicates the article and increases its mass. Necessity for layer-on-layer filling of the regenerative product into the cartridge during successive placing of the horizontal grids into the cartridge, substantially increases laboriousness of the article assemblage.

It is known also a regenerative cartridge of a rebreather of UA, 56898 U, IPC A62B 19/00, A62B 7/08, filing date Dec. 8, 2010, which consists of a housing with an inhale-exhale socket for connection with an air conduit, a lid bearing a shell, and a central tube made of a metal grid and fixed on the lid. The shell is arranged with an annular gap between its wall and the housing. The annular gap is connected with an inhale-exhale socket. The central tube is connected with inner space of the breathing bag. Inside of the shell (between the shell and central tube) a regenerative product and a plate heat-gas distributor are arranged. Plates of the heat-gas distributor are in a radial positioning relatively to the central tube and are connected between them by means of a peripheral hoop. The plates are not perforated. The regenerative product is pressed by the bottom equipped with springs. Between the regenerative product and the lid of the housing, as well as between the regenerative product and the bottom, there are glass-fiber interlayers, which prevent passing of the air-gas mixture over the lid and bottom surfaces, that is by-passing the granular regenerative product. The housing of the cartridge has a round form, which insure a uniform usage of the regenerative product layers in all directions, allows to decrease the mass of the regenerative product, the breath resistance, and the temperature of inhaled air. Using the shell and the central tube made of a metal grid, allows to reduce the production price owing to decreasing of metal consume for the regenerative cartridge and getting a possibility to employ the regenerative products of different fractions in the cartridge.

This the prior art regenerative cartridge functions in such a way.

At exhale, the air-gas mixture having a large carbon dioxide content, through a socket enters the annular gap between the housing of the cartridge and the grid shell, passes through the grid shell and the regenerative product, in which reactions of absorbing carbon dioxide and producing oxygen are occurred. Then, the air-gas mixture through the central tube comes into the breathing bag. During inhale, the air-gas mixture, in which the regeneration reactions have been completed, flows from the breathing bag in opposite direction while being reached additionally with oxygen.

Common features of the prior art and claimed solutions are as follows: a regenerative cartridge of a rebreather, which includes a hermetic housing with an inhale-exhale socket and a socket of a breathing bag, a perforated shell arranged in the housing with an annular gap between it and the side walls of the housing and made so as to have a central channel with perforated walls, a regenerative product arranged in the room of the perforated shell, a heat-gas distributor arranged in the bulk of the regenerative product.

However, the pendular scheme of the air-gas mixture passage, which provides a connection of the inhale-exhale socket with the annular gap between the shell and the housing, including a connection of the breath bag hole with the central perforated tube, increases a volume of the air-gas mixture which does not take part in the regeneration process (called a “harmful volume”), that gives an increase of the carbon dioxide content in the gas mixture inhaled by user.

In addition to this, the peripheral hoop, connecting the plates of the heat-gas distributor, increases the breath resistance and “shades” the regenerative product attaching to the hoop, which makes worse a uniformity of penetration of the air-gas mixture into the regenerative product.

Besides, lack of the perforation in the heat-exchange plates worsens the gas-dynamic of the regeneration process, since it embarrasses the penetration of the air-gas mixture deep in the bulk of the regenerative product.

As the most relevant document, a regenerative cartridge of a rebreather known from RU, 2414941, IPC A62B 19/00, filing date Dec. 23, 2009, have been chosen.

In this case, the regenerative cartridge of a rebreather comprises an oval hermetic housing, a perforated oval shell with a lid and a central channel formed by a perforated tube positioned along the longitudinal axis of the cartridge. The perforated shell is placed inside the housing with a gap between the shell and the side wall of the housing. Upper end of the perforated tube is connected with an inhale-exhale socket, while its lover end is closed. The gap between housing and perforated shell is connected with the socket of the breathing bag. In the room of the perforated shell, there placed a regenerative product. In the bulk of the regenerative product a heat-gas distributor is arranged. The heat-gas distributor is made as a cylinder composed of the three coaxial perforated shells connected between them. The medium perforated shell is convoluted. Besides, the end parts of the heat-gas distributor are held in contact with the lid of the perforated shell.

This prior art regenerative cartridge functions as follows.

The air-gas mixture from the user's respiration organs comes into the central channel, formed by the perforated tube. Further, through the perforation of the tube, the air-gas mixture enter the room of the perforated shell filled with the regenerative product; there a regeneration process begins—absorption of steam and carbon dioxide, and release of oxygen by the regenerative product. Heat energy, created in consequence of exothermic processes, serves for heating the air being regenerated, which passes sequentially through the shells of the heat-gas distributor—first through the its inner part, then through the middle part, and then through the external part, into the room of the perforated shell. At that, a larger part of the heat from the regenerated air flow, as a result of high heat conductivity of a metal, is transferred to the heat-gas distributor, further—to the lid of the shell through contacting surfaces, and further to the metal housing of the cartridge, from which the heat energy dissipates into the environment. Lesser quantity of the heat energy is accumulated by the regenerative product.

Common features of the prototype and claimed solutions are: a regenerative cartridge of a rebreather, including a hermetic housing, with an inhale-exhale socket and a socket of a breathing bag; a perforated shell arranged in a housing with an annular gap between the side wall of the housing and the shell and made with a central channel having perforated walls; a regenerative product arranged in the room of the perforated shell; a heat-gas distributor arranged in the bulk of the regenerative product, where said central channel is connected with the inhale-exhale socket and said annular gap is connected with the socket of the breathing bag.

Disadvantages of the regenerative cartridge, chosen as the most relevant, are such as:
lack of elements of a heat-gas distributor in the most active zone of exothermic reactions (around the central channel) increases a probability of a local high-temperature zone formation associated with a possible melting of components of the regenerative product, which makes worse the gas-dynamic of the gas passage through the bulk of the regenerative product, and decreases the regenerative product usage degree;
low efficiency of heat extraction toward the shell (the structure with a sufficiently high heat capacity) because the elements of the heat-gas distributor do not contact directly with the shell, which limits possible ways of heat elimination from the bulk of the regenerative product;
an oval form of the housing and shell causes a non-uniformity of usage of the regenerative product owing to a non-uniform distribution of the air-gas mixture flows through the bulk of the regenerative product.

All said above makes worse the conditions of heat-mass transfer in the regenerative cartridge and decreases the efficiency of the process of regeneration of the air-gas mixture.

In addition, it should be marked that positioning of a cylindrical heat-gas distributor in the axial direction in the room of the shell, with a rest on the lid of the shell, induces technical problems of holding of the regenerative product in a constantly pressed state. Shrinkage of the regenerative product in its upper part may cause formation of cavities, through which the air-gas mixture will pass omitting the regenerative product, which will decrease the efficiency of regeneration.

The main object of the claimed invention is to improve the regenerative cartridge of a rebreather by virtue of improvement of the heat-mass transfer conditions in the regenerative cartridge, and as a result to increase the efficiency of the air-gas mixture regeneration process without decreasing the manufacturability of the article.

For obtaining the above technical results it is claimed a regenerative cartridge of a rebreather, which includes: a hermetic housing with an inhale-exhale socket and a socket of a breathing bag; a perforated shell arranged in the housing with an annular gap between the side wall of the housing and the shell made with a central channel having perforated walls; a regenerative product arranged in the room of the perforated shell; a heat-gas distributor arranged in the bulk of the regenerative product; where said central channel is connected with the inhale-exhale socket, and said annular gap is connected with the socket of the breathing bag, where in accordance with the claimed invention the heat-gas distributor is made in a form of the perforated plates positioned in a radial arrangement in the bulk of the regenerative product between the perforated shell and the central channel, one of the lateral sides of each perforated plates is made with a longitudinal bend of L-shaped cross-section, the walls of the L-shaped bends of the neighboring perforated plates are successively connected between them so as to form the central channel confined by shelves of the L-shaped bends.

These features are the substantial ones of the claimed invention.

It is preferred also to make the housing and the perforated shell in cylindrical form, so as to insure a uniform usage of the regenerative product in all directions.

It is preferred that each of the parts of the perforated plates, located in the bulk of the regenerative product, was made with a longitudinal bend, so as to increase the surface of contact of the perforated plates with the regenerative product and air-gas mixture.

Besides, it is preferred to block the central channel in its lower part with a plug made of a gas-permeable material, collapsible under mechanical forces, and to place the channel so as to insure a rest for it on the bottom of the housing. Said structural feature allows to maintain constantly a collapsed state of the regenerative product.

It is preferred also to make the perforated plates of a metal grid material so as to increase the manufacturability of the structure.

The substantial features of the invention are in a cause-effect relation with the result to achieve.

Thus, distinctive features of the invention (heat-gas distributor made in the form of perforated plates positioned in a radial arrangement in the bulk of the regenerative product between the perforated shell and the central channel; one of the lateral sides of each perforated plate is made with a longitudinal bend of L-shaped cross-section; the walls of the L-shaped bends of the neighboring perforated plates are successively connected between them so as to form a central channel confined by the shelves of the L-shaped bends) in combination with its substantial features, being common with those of the prototype, insure an increase of the effectiveness of the air-gas mixture regeneration process owing to improvement of the heat-mass transfer conditions in the regenerative cartridge.

It may be clarified by the following

Realization of the heat-gas distributor in the form of perforated plates positioned in a radial arrangement between the perforated shell and central channel, and contacting with these, insure a uniform distribution of the temperature and air-gas mixture flows through the bulk of the regenerative product, an effective heat removal from the most active zone of exothermic reactions (around the central channel), which prevents creation of the local high-temperature zones followed by a possible melting of components of the regenerative product and, as a result, by worsening of the gas-dynamic of the gas passage through the bulk of the regenerative product, and a decrease of the regenerative product usage degree.

Perforated plates of the heat-gas distributor contact directly with the shell, which favors an effective heat removal from the bulk of the regenerative product toward the shell, which is a constructional element with a sufficiently high heat-capacitance, and further into the environment.

Cylindrical form of the housing and of the shell insures an uniform usage of the regenerative product layer in all directions.

Form of the perforated plates with a longitudinal bend allows to increase their surface of contact with the regenerative product and air-gas mixture, eases penetration of the air-gas mixture deep into the bulk of the regenerative product.

All said above is aimed to improve the heat-mass transfer conditions in the regenerative cartridge and to increase the effectiveness of the air-gas mixture regeneration process.

Identity of the perforated plates to each other, use of the metal grid material for their manufacture, as well as allowance to realize a connection between the identical plates, while simultaneously forming the central perforated channel, substantially increases the manufacturability of the article.

Below, a detailed description of the claimed regenerative cartridge of a rebreather is presented with references to the drawings attached, where:

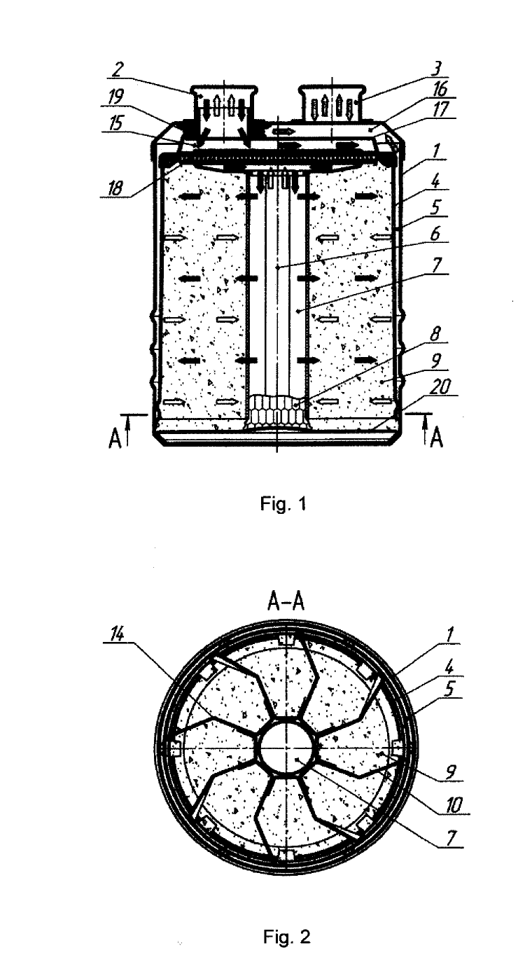

FIG. 1 is a view of the longitudinal section of the regenerative cartridge of a rebreather.

FIG. 2 is a view along lines A-A of FIG. 1 of the regenerative cartridge of a rebreather.

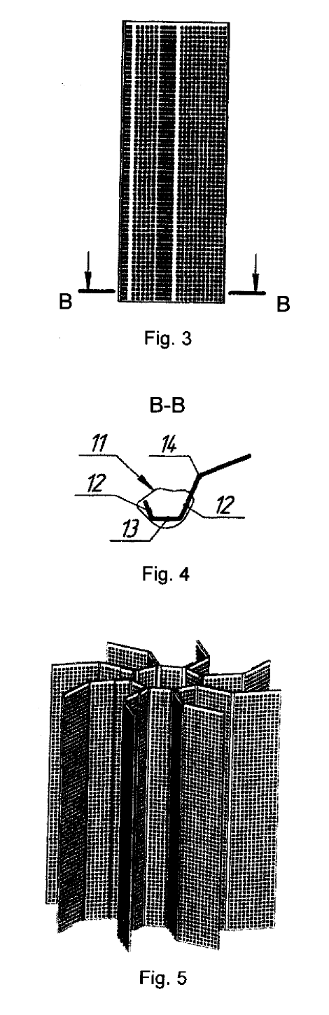

FIG. 3 shows the regenerative cartridge of a rebreather and the perforated plates of the heat-gas distributor.

FIG. 4 is a view along lines B-B of FIG. 3 of the regenerative cartridge of a rebreather.

FIG. 5 shows the regenerative cartridge of a rebreather and the heat-gas distributor in assembled state.

The regenerative cartridge of a rebreather comprises a hermetic cylindrical housing 1 with an inhale-exhale socket 2 for connection with a convoluted tube (not shown), a socket 3 of a breathing bag (not shown), a perforated shell 4 arranged in the housing 1 with an annular gap 5 between the shell and the side wall of the housing 1. The annular gap 5 is connected with the socket 3 of the breathing bag. Along longitudinal axis 6 of the regenerative cartridge there is a central channel 7 with perforated walls arranged, which at its one end is blocked with a plug 8 and at its other end is connected with the inhale-exhale socket 2. The plug 8 is made of a gas-permeable material, collapsible under action of mechanical forces. In the room of the perforated shell 4 a regenerative product 9 is arranged. The regenerative cartridge has a heat-gas distributor positioned in the bulk of the regenerative product 9 and made in the form of identical perforated plates 10, positioned in a radial arrangement in the bulk of the regenerative product 9 between the perforated shell 4 and central channel 7. The perforated plates 10 may be made of a metal grid material. Use of the identical perforated plates 10 in the structure of the heat-gas distributor and manufacturing them from a metal grid material increases manufacturability of the article. One of the lateral sides of each of the perforated plates 10 is made with a longitudinal bend 11 of L-shaped cross-section. Walls 12 of the L-shaped bends 11 of the neighboring perforated plates 10 are successively connected between them by means of contact welding. At such connection, a central channel 7 is formed, which is confined by shelves 13 of the L-shaped bends 11. Those parts of the perforated plates 10, which are located in the bulk of the regenerative product 9, are provided each with a longitudinal bend 14 to increase a surface of contact of the perforated plates 10 with the regenerative product 9. Perforated plates 10 may be manufactured from a metal grid material to increase the manufacturability of the structure.

In the upper part of the housing, there are two cavities 15, 16 isolated from each other and separated by a lid 17. The cavity 15 connects the exhale-inhale socket 2 with the central channel 7. The cavity 16 connects the socket 3 of the breathing bag with the annular gap 5 between the perforated shell 4 and the side wall of the housing 1. In the cavity 15 is arranged a filter 18. The lid 17 is sprig-loaded by a spring 19 relatively to the housing 1. The cartridge, in the lower part of its inner structure (the perforated shell 4 with the central channel 7, the regenerative product 9, the perforated plates 10), rests on the bottom 20 of the housing 1 through the plug 8, which is made of a gas-permeable material, collapsible under action of mechanical forces. Such a structure allows to maintain constantly a collapsed state of the regenerative product 9 with a force defined by the characteristics of the spring 19.

The claimed regenerative cartridge of a rebreather functions as follows.

At exhale, the air-gas mixture, containing a large quantity of carbon dioxide, through the socket 2 enters the cavity 15 and through filter 18 comes into the central channel 7. Further air-gas mixture passes through perforated shelves 13 of the L-shaped bends 11, which confine the central channel 7, and comes into the bulk of the regenerative product 9, in which reactions of absorption of carbon dioxide and release of oxygen take place. Perforated plates 10 favor uniform heat distribution in the bulk of the regenerative product 9, prevent arising of local high-temperature zones, remove the released heat toward the walls of the housing 1 and further in the environment. Some part of the air-gas mixture comes deep into the bulk of the regenerative product 9 by perforated plates, which improves the gas-dynamic of the regeneration process. Further, the air-gas mixture through the perforated shell 4 enters an annular gap 5 between the perforated shell 4 and the side wall of the housing 1, and through the cavity 16 comes into the socket 3 of the breathing bag.

At inhale, the air-gas mixture, in which regeneration reactions have been already accomplished, comes from the breathing bag in opposite direction, that is in passing “socket 3—cavity 16—annular gap 5—bulk of the regenerative product 9—central channel 7—filter 18—cavity 15—socket 2”. While this, the air-gas mixture is additionally exposed to the regeneration.

Assemblage of the cartridge is carried out in the following way.

At first, the filter 18 with the elements of its fixation is placed into the lid 17. The lid 17 is connected with the perforated shell 4 by means of contact welding. Walls 12 of the L-shaped bends 11 of the neighboring perforated plates 10 are successively connected with each other, forming the central channel 7. Been welded, the perforated plates 10, as a heat-gas distributor, are placed into the perforated shell 4 and fixed by means of contact welding. Into the lower part of the central channel 7, there is placed the plug 8 made of a gas-permeable material collapsible under action of mechanical forces, so as to insure a rest for the plug 8 on the bottom 20 of the housing 1. Assembled in such a way, the structure is placed into the housing 1 while pressing the spring 19. After this, the spring 19 is fixed by a letch in a pressed state. Further, the room of the perforated shell 4 is filled with the regenerative product 9, which then is compacted in a vibrator. After this, there is attached the bottom 20, which is welded hermetically with the housing 1. Further, the letch of the spring 19 is removed. The cartridge is ready to use.

The constructive realization of the claimed regenerative cartridge insures uniformity of the temperature and air-gas mixture flows through the bulk of the regenerative product, prevents arising of the local high-temperature zones, which improves the heat-mass transfer conditions in the regenerative cartridge and consequently increases efficiency of the air-gas mixture regeneration process. The proposed regenerative cartridge is characterized by a simplicity and a high manufacturability.

1. A regenerative cartridge of a rebreather comprising a hermetic housing with an inhale-exhale socket and a socket of a breathing bag, a perforated shell arranged in the housing with an annular gap between the side wall of the housing and the shell made with a central channel having perforated walls, a regenerative product arranged in the room of the perforated shell, a heat-gas distributor arranged in the bulk of the regenerative product, where said central channel is connected with an inhale-exhale socket, and said annular gap is connected with the socket of the breathing bag,
characterized in that
the heat-gas distributor is made in a form of perforated plates positioned in a radial arrangement in the bulk of the regenerative product between the perforated shell and the central channel, one of the lateral sides of each perforated plate is made with a longitudinal bend of L-shaped cross-section, the walls of the L-shaped bends of the neighboring perforated plates are successively connected between them so as to form a central channel confined by the shelves of the L-shaped bends.

2. The regenerative cartridge of claim 1, characterized in that the housing and the perforated shell are made in cylindrical form.

3. The regenerative cartridge of claim 1, characterized in that the parts of the perforated plates, located in the bulk of the regenerative product, are made each with a longitudinal bend.

4. The regenerative cartridge of claim 1, characterized in that the central channel in its lower part is blocked by a plug made of a gas-permeable material, collapsible under the mechanical forces, and placed so as to insure its rest on the bottom of the housing.

5. The regenerative cartridge of claim 1, characterized in that the perforated plates are made of a metal grid material.
